(19) United States
(12) Patent Application Publication
(10) Pub. No.: US 2013/0246211 A1
(43) Pub. Date: Sep. 19, 2013

(54) SYSTEM AND METHOD FOR PROVIDING MOBILE DEVICE TRADE IN VALUE QUOTATIONS

(71) Applicant: Robert Flinn Sullivan, Bloomfield Hills, MI (US)

(72) Inventor: Robert Flinn Sullivan, Bloomfield Hills, MI (US)

(21) Appl. No.: 13/418,901

(22) Filed: Mar. 13, 2012

(51) Int. Cl. G06Q 30/00; H04W 4/12

(52) U.S. Cl. 705/26.4

(57) ABSTRACT

A system and method for providing a trade-in price quotation to a mobile device. The system receives from the mobile device a quote request including information associated with at least one characteristic of the mobile device, such as the make and model of the mobile device. The system interprets the information to identify the at least one characteristic of the mobile device and sends the at least one characteristic to a pricing database that returns a mobile device value amount based at least in part upon the at least one characteristic of the mobile device. The system calculates a trade-in price quotation based upon at least the mobile device value amount and sends the trade-in price quotation to the mobile device.

### FIELD OF THE INVENTION

The present invention relates generally to systems and methods for providing mobile device trade in value quotations.

### BACKGROUND

When mobile device manufacturers release new mobile devices and/or new versions of mobile devices, many customers choose to update their mobile devices even though their existing mobile devices are still in good working condition. As a result, there is an available supply of used but functional mobile devices. Furthermore, there is a demand for pre-owned units of mobile devices that are already on the market. For example, some people grow attached to a particular device and, if they lose or damage their device, they may want to purchase a used replacement of the same make and model. Others may seek less expensive mobile devices for family members (such as children) or to save on IT expenditures for a small business. Thus, a market exists for third parties to purchase used but still viable mobile devices and to re-sell the mobile devices to others.

### SUMMARY

In some aspects, a system is provided for providing a trade-in price quotation to a mobile device. The mobile device is operable to send a quote request and the quote request includes information associated with at least one characteristic of the mobile device. The system includes a first server for receiving the quote request. The first server includes a recognition module for identifying the at least one characteristic of the mobile device from the quote request information. A pricing module communicates with the recognition module and receives from the recognition module the at least one characteristic of the mobile device from which the quote request was sent. The pricing module is operable to access pricing database that returns a mobile device value amount based at least in part upon the at least one characteristic of the mobile device from which the quote request was sent. The pricing module is also operable to calculate the trade-in price quotation. A communication module sends the trade-in price quotation to the mobile device. The trade-in price quotation includes at least the mobile device value amount. The quote request may be an http request, and the information may be user agent information.

In other aspects, a non-transitory tangible computer readable medium is provided. The computer readable medium is for controlling a computer and includes a plurality of code segments for providing a trade-in value price quotation to a mobile device. The mobile device is operable to send a quote request. The computer readable medium includes a code segment for receiving and interpreting the quote request to identify at least one characteristic of the mobile device, and a code segment for receiving the at least one characteristic of the mobile device and comparing the at least one characteristic of the mobile device to information contained in a pricing database to determine a mobile device value amount based at least in part upon the at least one characteristic of the mobile device. The computer readable medium also includes a code segment for calculating the trade-in value price quotation of the mobile device, the trade-in value price quotation including at least the mobile device value amount, and a code segment for sending the trade-in value price quotation to the mobile device.

In still other aspects, a method for providing a trade-in value price quotation to a mobile device includes receiving at a server a quote request from the mobile device, the quote request including information associated with at least one characteristic of the mobile device. A code segment contained on a non-transitory tangible computer readable medium is executed for interpreting the information to at least partially determine the at least one characteristic of the mobile device. The at least one characteristic of the mobile device is sent to a pricing database. The pricing database includes a plurality of mobile device value amounts. One of the plurality of mobile device value amounts is identified that corresponds at least in part to the at least one characteristic of the mobile device. A trade-in value price quotation is calculated for the mobile device. The trade-in value price quotation includes at least the mobile device value amount. The trade-in value price quotation is sent to the mobile device.

### BRIEF DESCRIPTION OF THE DRAWINGS

FIG. 1 is a schematic illustration of a system for automatically providing trade-in value quotes for a mobile device.

FIG. 2 is a schematic flow chart showing methods for receiving a request for a trade-in quote from a mobile device.

FIG. 3 is a schematic flow chart showing a method for determining the make and model of a mobile device and for generating a trade-in value quote for the mobile device.

FIGS. 4A-4C are screenshots showing user interface displays associated with a first fulfillment option.

FIGS. 5A-5C are screenshots showing user interface displays associated with a second fulfillment option.

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

### DETAILED DESCRIPTION

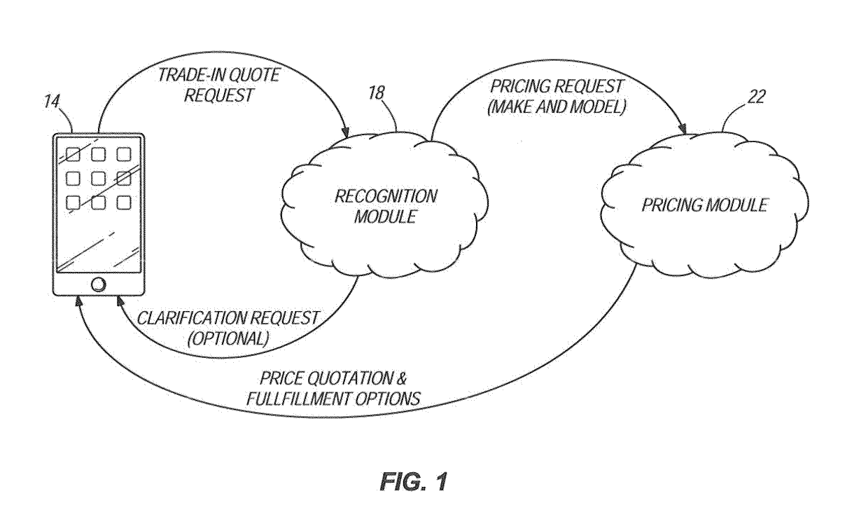

FIG. 1 is a schematic illustration of a system 10 for automatically providing trade-in value, quotes for a mobile device 14 in response to an inquiry sent from the mobile device 14. The system 10 is implemented by way of a combination of hardware, software, and various telecommunication pathways. The system 10 includes a recognition module 18 operable to send, receive, and process information generally relating to the task of identifying the make and model of the mobile device 14 for which the trade-in value quote is being requested. The system also includes a pricing module 22 operable to send, receive and process information relating to the task of calculating a suitable trade-in value for the mobile device 14. Both the recognition module 18 and the pricing module 22 are generally embodied as software being executed by suitable hardware such as one or more servers having access to various databases and communication capabilities. In this regard, the recognition module 18 and the pricing module 22 can be located on the same server or on different servers, and are operable to communicate with one another and with the mobile device 14 by way of one or more telecommunication networks, including the Internet, for example by way of one or more http requests.

As shown in FIG. 1, high level operation of the system proceeds as follows: A user of the mobile device 14 interested in obtaining a trade-in value quote for the mobile device 14 operates the mobile device 14 to initiate and send a trade-in quote request to the recognition module 18. As discussed further below, the trade-in quote request can take on a variety of forms, but regardless of the form at least a portion of the trade-in quote request includes user agent information associated with the make and model of the mobile device or from which the make and model can be determined. The recognition module 18 receives the trade-in quote request, including the user agent information, and uses the user agent information to identify or determine the make and model of the mobile device 14 from which the trade-in quote request was sent. If the recognition module 18 is unable to determine precisely the make and model of the mobile device 14 based on the request, an optional clarification request message can be sent back to the mobile device 14 seeking additional information regarding the specific make and model of the mobile device 14. The clarification request message can also or in the alternative seek additional information, such as the condition of the mobile device 14.

After the system 10 has identified the specific make and model of the mobile device 14, and optionally obtained information about the condition of the mobile device 14, the recognition module 18 sends a pricing request to the pricing module 22. The pricing request includes information about the make and model of the mobile device 14 and optionally includes other information about the device 14, such as the condition of the mobile device 14. The pricing module 22 receives the pricing request, analyzes the information contained therein, and calculates or retrieves a price quotation corresponding to a dollar amount that is to be provided to the user of the mobile device 14 as the trade-in value of his or her mobile device 14. The price quotation is then sent to the mobile device 14 and the user may also be presented with one or more fulfillment options for completing the transaction by turning over possession of the mobile device and receiving in exchange the dollar amount provided in the price quotation. One or more communication modules (not shown) are associated with the recognition module 18, the pricing module 22, and the one or more servers hosting the recognition module 18 and the pricing module 22 to coordinate communication between the modules 18, 22 and the mobile device. Communications to and from the modules may be in the form of http messages, sms or text messages, or other electronic communication.

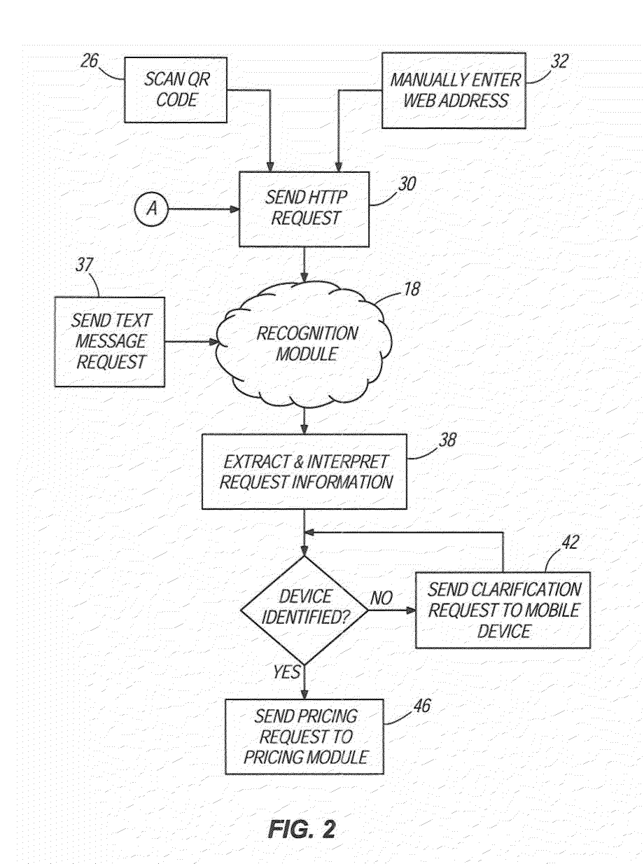

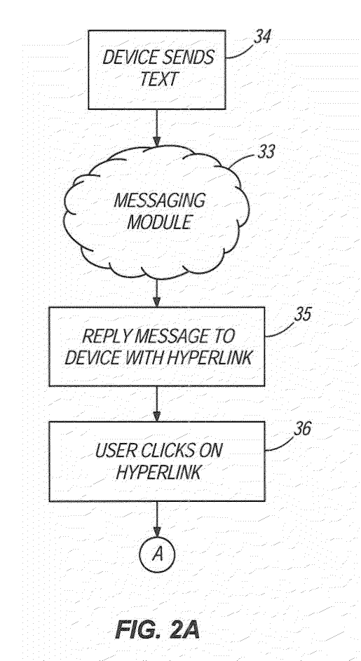

Referring also to FIG. 2, a first method for receiving a trade-in quote request includes at 26 the user scanning a quick response code or “QR code” with the user's mobile device 14. QR codes are known in the art and can be configured such that upon scanning the QR code the mobile device 14 automatically opens a web browser and sends an http request to a web address that is associated with the recognition module 18, as at 30, or performs some other function. QR codes are particularly well suited for use with printed materials such as bill staffers, news letters, magazines, newspapers, Sunday circulars, mailers, and in-store point of sale collateral. Regardless of the specific item from which the QR code is scanned or the specific mobile device application that is launched in response to scanning the QR code, the QR code is configured such that after scanning the QR code the mobile device sends a trade-in quote request to the recognition module 18.

In a second method for receiving a trade-in quote request, the user can initiate the process without scanning a QR code by manually entering a web address associated with the recognition module 18 into the mobile web browser on the mobile device 14, as at 32. Manually entering the web address into the mobile web browser and pressing “enter” or “go” sends the http request to the recognition module as at 30. Use of the web browser is particularly well suited for mass email or text message campaigns where emails or text messages, frequently including a hyperlink, are sent to large numbers of users.

Referring also to FIG. 2A, in a third method for receiving a trade-in quote request, the user can initiate the process by composing and sending a text message (SMS) to a messaging module 33, as at 34. In some embodiments the text message can use “short codes” to simplify the process of composing and sending the text message. The messaging module 33 is configured to receive and interpret the contents of the text message sent from the mobile device 14, including interpretation and processing of the short code, if present. The messaging module 33 can be located on the same server as the recognition module 18 and/or the pricing module 22, or can be located on its own server.

In response to receiving a trade-in quote request by way of text message, the messaging module 33 sends a reply message back to the mobile device 14 as at 35. The reply message includes a hyperlink to a web address associated with the recognition module 18. In some embodiments, the web address included in the hyperlink of the reply message can be the same web address used in the above-described embodiments associated with scanning a QR code and/or manually entering the web address. Once the user receives the reply message, the user can click on the hyperlink, as at 36, which sends the http request to the recognition module as at 30 (see FIG. 2).

In a fourth method for receiving a trade-in quote request, the user can send a text message directly to the recognition module 18, as at 37. The text message can be sent to the recognition module as a standard SMS or MMS text message or using a short code. In some embodiments the user can be instructed to include the make and model of his or her mobile device in the body of the text message. In other embodiments the recognition module 18 can be configured to identify the make and model of the mobile device based on information contained or embedded within the SMS or MMS data stream.

Text messages and short code text messages as used in the third and fourth methods discussed above can be particularly well suited for use at large events, in multimedia campaigns, or in mobile advertising, such as targeted campaigns, billboards, stadium events, buses, TV and radio advertising, college programs, and for customers whose mobile devices lack the ability to scan a QR code. One example of a short code text message could be texting the phrase “Tradein” to a 5-digit short code number associated with the recognition module 18.

Regardless of how a user arrives at the step of sending the http request 30 or text message request 37 to the recognition module, the request includes user agent or other information that is extracted from the request and interpreted by the recognition module 18, as at 38. In one embodiment, the recognition module 18 extracts the user agent information from the http request and compares it to a database of user agent information that correlates user agent information with specific makes and models of mobile devices. In other embodiments, the recognition module 18 evaluates the content of the body of the text message and extracts the make and model of the mobile device from the text using one or more text and natural language evaluation protocols.

In many instances the recognition module 18 is able to determine the specific make and model of the mobile device 14 based solely on the user agent information. In some instances, however, the user agent information may be insufficient to determine the specific make and model of the mobile device 14, for example when there are several different but very similar versions of a certain make and model of mobile device. In such instances, the recognition module 18 can send a clarification request back to the mobile device 14, as at 42. The clarification request can be in the form of a text message, web page, or substantially any other method for communicating with the user of the mobile device. By way of example only, if the recognition module is unable to determine the specific make and model of the mobile device 14 using the user agent information, the recognition module 18 may be able to at least narrow down the possible makes and models of the mobile device 14 to a handful of possibilities. The clarification request may therefore include a list of the possible makes and models of the mobile device as determined by the recognition module 18 and may ask the user to identify the specific make and model by selecting it from the list. Once the recognition module 18 has determined the specific make and model of the mobile device 14, the recognition module 18 sends a pricing request to the pricing module 22, as at 46. In some embodiments, the recognition module 18 may be or include one or more commercially available services for detecting or identifying one or more of the mobile, device make, model, operating system, or web browser based on information included in an http request.

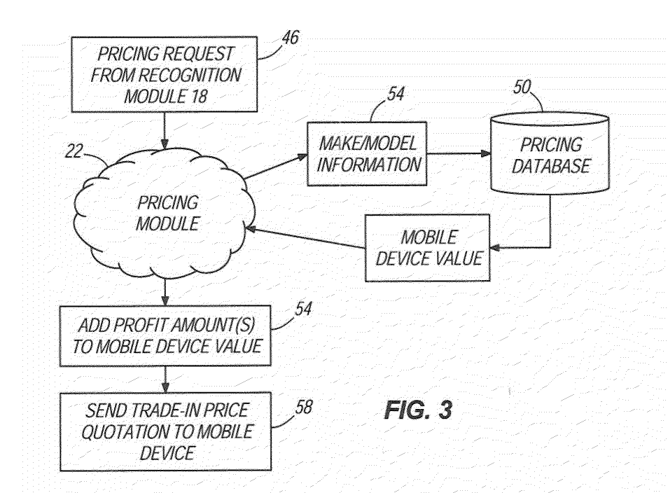

Referring also to FIG. 3, the pricing module 22 receives the pricing request from the recognition module 18 and sends at least the make and model information relating to the mobile device 14 to a pricing database 50, as at 54. The pricing database 50 includes lookup tables and algorithms that calculate or otherwise establish a mobile device value based upon at least the make and model of the mobile device. Other factors that may be included in the calculation or determination of a particular mobile device value include the condition of the mobile device 14, and the current market (supply and demand) for the mobile device 14. Mobile device values can be entered into the pricing database 50 manually or can be automatically updated based on information obtained by web crawlers, data miners, and the like. Some embodiments may rely on a combination of automatic updating and manual checking or approval of any automated changes to the pricing database 50.

In some embodiments, the pricing database 50 may provide the mobile device value as a range, where mobile devices in perfect or near perfect condition can be exchanged at the top of the range, and mobile devices in poor condition can be exchanged at the bottom of the range. In this regard, either the recognition module 18 or the pricing module 22 may send a request for information regarding the condition of the mobile device 14 to the mobile device 14. The mobile device value can also depend on, among other things, the user's location, the user's service provider, and any promotional codes associated with the user's request. For example, an advertisement may include a promotional line such as “Company XYZ customers—receive an extra $10 on the trade value of your phone if you text 12345 within the next 15 minutes.” If a Company XYZ customer completes the process within the allotted time, an additional $10 would be added to the mobile device value returned to the user. Similarly, customers can be offered a trade-up credit if, as part of trading in their existing mobile device, they agree to purchase a new version of a specific make and model of mobile device. Non-monetary promotional items can also be included in the advertisement and trade in value quote, such as gift certificates, product promotions, and the like.

Once the mobile device value has been determined by or returned to the pricing module 22, the pricing module 22 can optionally add or subtract one or more profit amounts to/from the mobile device value, as at 54, before sending a final trade-in price quotation to the mobile device 14. Profit amounts added to or subtracted from the mobile device value can include, for example, a profit amount allocated to the trade-in amount quotation service provider, a profit amount allocated to the advertiser that generated the inquiry from the user, and other profit amounts associated with other parties that may be involved in the transaction. Once the profit amounts and promotional codes, if any, have been added to the mobile device value, the trade-in price quotation is sent to the mobile device 14, as at 58.

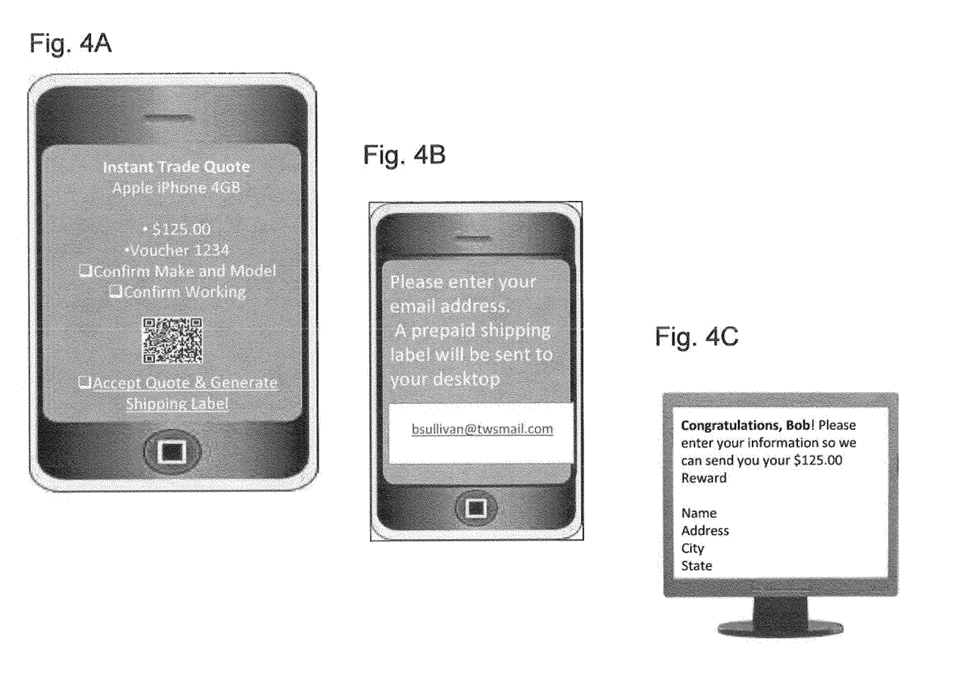

In addition to communicating a trade-in value or value range for the mobile device 14, the trade-in price quotation can also include one or more fulfillment options to assist the user in accepting the trade-in price quotation, turning over possession of the mobile device 14, and receiving payment. For example, with reference to FIGS. 4A-4C, one fulfillment option includes a mail back option in which the user mails his or her mobile device 14 into a service center and, once the mobile device 14 is received and its condition verified, payment is sent to the user. More specifically, as shown in FIG. 4A the trade-in price quotation is presented to the user and can include identification of the specific make and model of the mobile device 14, identification of the trade-in amount being offered, a voucher reference number, and check boxes for the user to confirm the proper make and model, to confirm the working condition of the mobile device, and to accept the quote and generate a shipping label.

Referring to FIG. 4B, once the user chooses to accept the quote and generate the shipping label, the user is prompted to provide an email address so that a prepaid shipping label can be emailed to the user for subsequent printing and application to suitable shipping packaging. With reference to FIG. 4C the user is also prompted to enter basic personal information such as name and address for inclusion on the shipping label. The personal information can be collected from a desktop or laptop computer, as shown, or could also be collected directly from the mobile device 14. Once all of the information has been collected from the user, the user prints the shipping label, ships the mobile device to the service provider, and, after receiving the mobile device and confirming the make, model, and condition, the service provider mails the user a check, deposits funds in the user's account, or otherwise transfers funds to the user. Printing of the shipping label can take place using a desktop or laptop computer or can be performed directly from the mobile device 14 using a remote or wireless printing system.

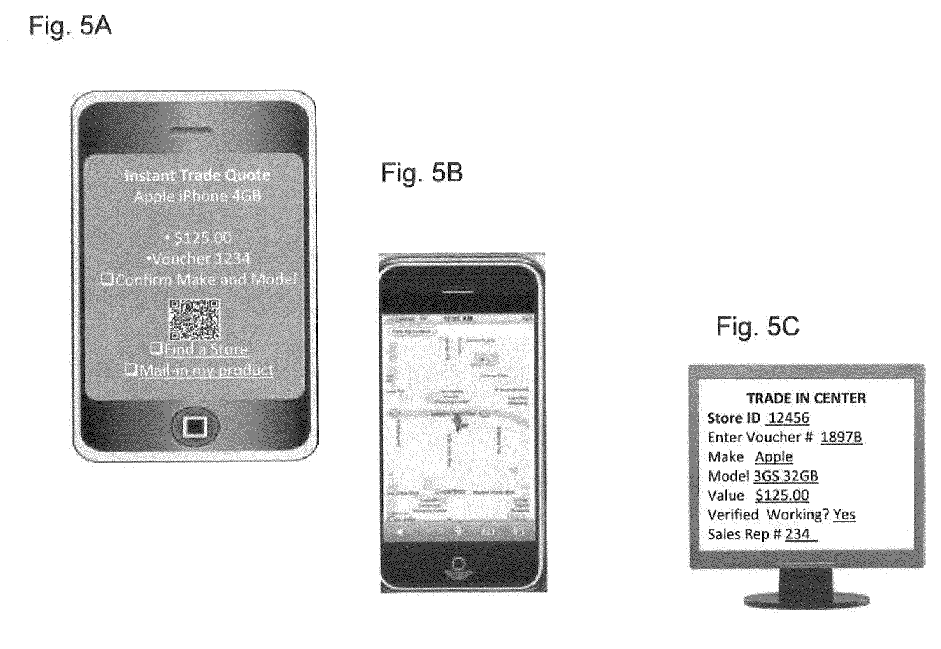

FIGS. 5A-5C illustrate a second fulfillment option that involves the user dropping the mobile device off at a brick and mortar retail location. As shown in FIG. 5A, in the retail fulfillment option the trade-in price quotation is presented in much the same way as the mail in fulfillment option shown in FIG. 4A, and includes the make and model of the mobile device 14, identification of the trade-in amount being offered, a voucher reference number, check boxes, and an option to either “Find a store” or “Mail-in my product.” If the user selects “Mail-in my product” the process proceeds as discussed above with respect to FIGS. 4A-4C. However, if the user selects “Find a store” the system accesses the geo-locating feature of the mobile device 14 and locates the nearest retail location where the mobile device 14 can be dropped off. Once the user arrives at the retail location, the retailer can scan a barcode or QR code displayed on the mobile device and associated with the specific trade-in price quotation previously provided to the user. The barcode or QR code includes information about the mobile device, the trade-in price quotation, and other information that is used by the retailer to confirm the user's participation in the system. Software on the retailer's transaction management system prompts the retailer to verify that the mobile device is working and, assuming the retailer is able to verify the working status and condition of the mobile device, the user turns the mobile device and the retailer pays the user the amount provided in the trade-in price quotation. For those instances where the trade-in price quotation was provided as a range, the retailer can make a judgment as to the actual condition of the mobile device and compensate the user accordingly.

Although the various embodiments discussed above are carried out at least in part by accessing a website, the system 10 could also be embodied as a native mobile application that is installed on the mobile device 14. Moreover, although the foregoing description relates specifically to providing a trade-in value quotation to a mobile device by detecting the make and model of the mobile device, the same or a similar system 10 could also be configured to provide other or additional information and/or promotional materials by detecting the make and model of the mobile device. For example, in response to an inquiry sent from the mobile device 14, the system 10 could be configured to send the user a list of available accessories specific to the mobile device. Such a system would rely on a recognition module similar to the recognition module 18, and would include a database similar to the pricing database 22 but including a list of accessories or other products associated with the detected mobile device 14.

1. A system for providing a trade-in price quotation to a mobile device, the mobile device operable to send a quote request, the quote request including information associated with at least one characteristic of the mobile device, the system comprising:
a first server for receiving the quote request, the first server including a recognition module for interpreting the information to identify the at least one characteristic of the mobile device from which the quote request was sent;
a pricing module communicating with the recognition module and receiving from the recognition module the at least one characteristic of the mobile device from which the quote request was sent, the pricing module operable to access a pricing database that returns a mobile device value amount based at least in part upon the at least one characteristic of the mobile device from which the quote request was sent, and to calculate the trade-in price quotation; and
a communication module for sending the trade-in price quotation to the mobile device, the trade-in price quotation including at least the mobile device value amount.

2. The system of claim 1, wherein the quote request includes an http request, and wherein the information includes user agent information.

3. The system of claim 1, wherein the quote request includes a text message, wherein the information includes text in a body of the text message associated with the make and model of the mobile device, and wherein the recognition module analyzes the text in the body of the text message to at least partially determine the at least one characteristic of the mobile device.

4. The system of claim 1, wherein the at least one characteristic of the mobile device includes a make and model of the mobile device.

5. The system of claim 4, wherein the recognition module is operable to send a clarification request to the mobile device, the clarification request including a list of mobile device makes and models.

6. The system of claim 1, further comprising a messaging module operable to receive a text message from the mobile device.

7. The system of claim 6, wherein the messaging module is operable to send a reply message to the mobile device, the reply message including a hyperlink for automatically sending the quote request to the first server.

8. The system of claim 1, wherein the trade-in price quotation includes information relating to at least one fulfillment option.

9. A non-transitory tangible computer readable medium for controlling a computer and comprising a plurality of code segments for providing a trade-in value price quotation to a mobile device in response to a quote request sent from a mobile device, the computer readable medium comprising:
a code segment for receiving and interpreting the quote request to identify at least one characteristic of the mobile device;
a code segment for receiving the at least one characteristic of the mobile device and comparing the at least one characteristic of the mobile device to information contained in a pricing database to determine a mobile device value amount based at least in part upon the at least one characteristic of the mobile device;
a code segment for calculating the trade-in value price quotation of the mobile device, the trade-in value price quotation including at least the mobile device value amount; and
a code segment for sending the trade-in value price quotation to the mobile device.

10. The computer readable medium of claim 9, wherein the quote request includes an http request, and wherein the code segment for receiving and interpreting the quote request includes a code segment for identifying and interpreting user agent information included in the http request to at least partially identify the at least one characteristic of the mobile device.

11. The computer readable medium of claim 9, wherein the quote request includes a text message, and wherein the code segment for receiving and interpreting the quote request includes a code segment for analyzing text included in the text message to at least partially identify the at least one characteristic of the mobile device.

12. The computer readable medium of claim 9, wherein the at least one characteristic of the mobile device identified by the code segment for receiving and interpreting the quote request includes a make and model of the mobile device.

13. The computer readable medium of claim 12, further comprising a code segment for sending a clarification request to the mobile device, the clarification request including a list of possible mobile device makes and models that might be associated with the mobile device.

14. The computer readable medium of claim 9, wherein the quote request is a text message, the medium further comprising a code segment for sending a reply message to the mobile device, the reply message including a hyperlink for automatically sending an http request.

15. The computer readable medium of claim 9, wherein the trade-in value price quotation includes information relating to at least on fulfillment option.

16. A method for providing a trade-in value price quotation to a mobile device, the method comprising:
receiving at a server a quote request initiated by the mobile device, the quote request including information associated with at least one characteristic of the mobile device;
executing a code segment contained on a non-transitory tangible computer readable medium for interpreting the information to at least partially determine the at least one characteristic of the mobile device;
sending the at least one characteristic of the mobile device to a pricing database, the pricing database including a plurality of mobile device value amounts;
identifying one of the plurality of mobile device value amounts that corresponds at least in part to the at least one characteristic of the mobile device;
calculating a trade-in value price quotation for the mobile device, the trade-in value price quotation including at least the mobile device value amount; and
sending the trade-in value price quotation to the mobile device.

17. The method of claim 16, wherein the quote request includes an http request, and wherein the information includes user agent information.

18. The method of claim 16, wherein the quote request includes a text message, and wherein executing the code segment includes analyzing text included in the code segment to at least partially determine the at least one characteristic of the mobile device.

19. The method of claim 16, wherein the at least one characteristic of the mobile device includes a make and model of the mobile device.

20. The method of claim 19, further comprising, before sending the at least one characteristic of the mobile device to the pricing database, sending a clarification request to the mobile device, the clarification request including a list of possible mobile device makes and models that might be associated with the mobile device.
